(19) United States
(12) Patent Application Publication
(10) Pub. No.: US 2011/0289783 A1
(43) Pub. Date: Dec. 1, 2011

(54) APPARATUS AND METHOD FOR PROVIDING A HAND-HELD INSTRUMENT WITH AT LEAST ONE SELECTIVELY OPERABLE RETRACTABLE PROTECTIVE ELEMENT

(76) Inventors: Erika Polyakova, Brooklyn, NY (US); Yakov Levin, Brooklyn, NY (US)

(21) Appl. No.: 13/151,210

(22) Filed: Jun. 1, 2011

Related U.S. Application Data
(60) Provisional application No. 61/350,463, filed on Jun. 1, 2010.

(51) Int. Cl. B26B 3/06

(52) U.S. Cl. 30/153; 30/151

(57) ABSTRACT

The present invention is directed to a hand-held instrument, which may comprise, in various exemplary embodiments thereof, a folding (manual, assisted opening, automatic, etc,) knife, a fixed blade knife, or any other hand-held tool comprising a handle, and at least one active region (e.g., a cutting, a saw blade, etc.), and which also advantageously comprises at least one novel user-operable protective element, that when placed, by the user, into an active position that is generally perpendicular to the handle of the instrument, is configured for protecting at least a portion of the user's hand while the instrument is held and/or utilized, and that when placed into a retracted position that is generally parallel to the handle of the instrument, streamlines the instruments longitudinal profile. In accordance with the present invention, the inventive apparatus is advantageously provided with at least one actuating element selectively operable by the user, that when activated, causes a corresponding at least one protective element to automatically extend into the active position. In an alternate embodiment of the present invention, in which the novel instrument comprises an automatic opening blade that exists a predefined region within the handle thereof in response to the user's activation of an opening element, the novel instrument is advantageously provided with an actuating mechanism connected to at least one protective element that is operable to automatically cause the at least one protective element to extend into its active position in conjunction with the blade's automatic opening movement.

### CROSS REFERENCE TO RELATED APPLICATIONS

The present patent application claims priority from the commonly assigned co-pending U.S. provisional patent application 61/350,463 entitled “Apparatus and Method for Providing a Hand-Held Instrument with at Least One Selectively Operable Retractable Protective Element”, filed on Jun. 1, 2010.

### FIELD OF THE INVENTION

The present invention relates generally to hand-held instruments having mechanically operable elements, and more particularly to an apparatus and method for providing any hand-held instrument, such as a fixed blade, folding, and/or automatic knife, or any other tool, with at least one user-operable retractable protective element configured for protecting at least a portion of the user's hand when the instrument is held and/or utilized.

### BACKGROUND OF THE INVENTION

Many hand-held instruments, such as knives, tools, and the like, often expose the hand of a user, during utilization thereof, to a wide variety of dangers and potential threats. These may range from the tendency of an instrument, such as a knife, to allow the user's hand to undesirably slide over the handle and then contact a dangerous portion thereof (such as the user's hand sliding along the handle of a knife and over the blade (e.g., when the handle is wet or slippery)), or an instrument's failure to protect the user's hand operating the instrument from external harm (e.g., an opponent's blade sliding along the blade of the user's knife and striking their hand, or a screwdriver slipping forward and causing the user's hand to contact harmful electrical wiring).

For many years, the only available solutions for the above-noted challenges have been developed for short and long-bladed weapons for military, personal combat, sport, and hunting purposes, most often provided as protective guards in form of fixed components of the bladed weapons equipped therewith, and often integrated into in the construction of the weapons themselves. Such conventional protective elements, in use for centuries in connection with various bladed weapons, include, but are not limited to, cross-guards, quillons, partial or full “D-guards”, basket hilts, and the like.

In addition to providing physical protection for the wielder's hand, certain types of protective guards (especially those incorporating fixed raised shielding elements, or those formed as basket hilts) also serve as psychological “morale/confidence boosters”, as they essentially represent a symbolic “interposing shield” or “protective barrier” between the wielder and his opponent during the weapon's use. Finally, protective guards on bladed weapons often provide a uniquely positioned, configured, and sized area for the weapon maker to provide embellishments and decorations of a purely aesthetic sort, or incorporating heraldic, or other “themed” or meaningful imagery, and the like.

While the above-described protective guards are capable of suitably perform their purposes, they all suffer from a significant disadvantage, in that they significantly increase the bulk of the weapon, and make it more difficult to transport and to deploy -- this drawback is especially problematic for smaller-sized instruments, such as knives, and is simply unacceptable for bladed instruments that are specifically intended for ease of carrying and “as-needed” deployment, such as folding knives.

Conventional hand-tools, such as hand saws, screwdrivers, awls, picks, chisels, and the like, do not utilize above-described protective guards at all, first for the same reasons as described above with respect to smaller knives, but most importantly because for the majority of the time, hand tools are utilized in a manner that does not require, or would not greatly benefit from, utilization of a protective guard, and therefore, the bulk added by an integrated protective guard to a hand tool, and its interference with the hand tool's operation cannot be justified. Unfortunately, for those rare circumstances where a protective guard would be a welcome feature on a tool, its absence can lead to very significant risk of injury to a user.

It would thus be desirable to provide a hand-held instrument with at least one selectively deployable protective element that is operable to serve as a protective guard when activated, and that can be readily retracted when it is not needed, to further streamline the instrument's physical profile for storage/transport thereof. It would also be desirable to provide a hand-held instrument having a selectively deployable (e.g., folding, retractable, etc.) active component (blade, etc.), and having at least one selectively deployable retractable protective element, where a single mechanism is provided in the instrument, with an engageable actuating element that is selectively operable by a user to deploy, upon engagement thereof, both the active component and the protective element, wherein the active component and the protective element are selectively retractable by the user. It would further be desirable to provide a hand-held instrument having a selectively deployable active component, and having at least one selectively deployable retractable protective element, with individual mechanisms provided in the instrument therefor, each with an engageable actuating element that is selectively operable by a user to deploy, upon engagement thereof, the corresponding one of the active component and the protective element. It would moreover be desirable to provide a protective module, operable for being mounted on, or incorporated into, any suitable hand-held instrument, the protective module having a selectively deployable protective element that is operable to serve as a protective guard when activated, and that can be readily retracted when it is not needed.

### BRIEF DESCRIPTION OF THE DRAWINGS

In the drawings, wherein like reference characters denote corresponding or similar elements throughout the various figures:

FIG. 1A is an exemplary schematic diagram illustrating a top-down view of a first exemplary embodiment of the inventive hand-held apparatus, configured, by way of example, as a knife having a mechanically deployable blade component, and comprising at least one user-operable retractable protective element that is advantageously configured for automatically moving into a protective position in response to selective actuation of a corresponding at least one actuating element, that is also operable to cause the blade component to mechanically deploy, said at least one protective element being shown in an inactive retracted position;

FIG. 1B is an exemplary schematic diagram illustrating a side view of the exemplary first embodiment of the inventive hand-held apparatus illustrated in FIG. 1A, wherein said at least one protective element is shown in an active extended position;

FIG. 2A is an exemplary schematic diagram illustrating a top-down view of a second exemplary embodiment of the inventive hand-held apparatus configured, by way of example, as a knife having a fixed or a folding blade (or any other equivalent “active” component), and also comprising at least one user-operable retractable protective element, that is advantageously configured for automatically moving into a protective position in response to selective actuation of a corresponding at least one actuating element, which may optionally be provided solely for such selective actuation thereof, said at least one protective element being shown in an inactive retracted position;

FIG. 2B is an exemplary schematic diagram illustrating a side view of the exemplary embodiment of the inventive hand-held apparatus illustrated in FIG. 2A, wherein said at least one protective element is illustrated, by way of example, as a pair of protective elements that are each shown in their active extended positions; and

FIG. 3, is an exemplary schematic diagram illustrating a side view of an alternate exemplary embodiment of the inventive hand-held apparatus, shown as any hand-held instrument having a predetermined active component (e.g., a blade, a screwdriver shaft, an awl spike, etc.) and a handle, and having at least one retractable selectively operable protective element component attached thereto.

### SUMMARY OF THE INVENTION

The various embodiments of the apparatus of the present invention, advantageously remedy and resolve the disadvantages and drawbacks of all previously known solutions for providing protective features for hand-held instruments, such as weapons and tools, that are intended for protection of the users' hands and/or fingers during the instruments' utilization.

In summary, the present invention is directed to a hand-held apparatus, which may comprise, in various exemplary embodiments thereof, any hand-held instrument, including, but not limited to, a folding knife (which may be “manual opening”, “assisted opening”, automatic, etc,), a fixed blade knife, or any other hand-held tool, that comprises a handle component by which it is held by the user during utilization thereof, and at least one “active” component (e.g., a portion of the instrument that is capable of performing one or more predetermined functions, such as a blade for cutting, a saw for sawing, a screwdriver head for use with screws, etc.).

The essence of the inventive apparatus in various exemplary embodiments thereof, is that it also advantageously comprises at least one novel user-operable retractable protective element, that, when placed by the user, into an active position that is at a predefined angle (and, preferably, generally perpendicular) to the instrument's handle component, is configured for protecting at least a portion of the user's hand (and/or fingers thereof) while the instrument is held and/or utilized, and that when placed into a retracted position, that is preferably generally parallel to the handle component of the instrument, streamlines the instrument's longitudinal profile.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

In various embodiments of the present invention, the inventive apparatus comprises a hand-held instrument such as a weapon or a tool (e.g., a knife, etc.) that may be of a folding or a fixed configuration, that is advantageously provided with at least one actuating element, selectively operable by the user, that when activated, causes a corresponding at least one protective element to automatically extend into a predetermined active position, which is preferably substantially perpendicular to the handle thereof (but which position, in alternate embodiments of the present invention, may be at any desired predetermined practical angle to the handle component (e.g., between 45 degrees and 90 degrees).

In at least one other exemplary embodiment of the present invention, in which the novel instrument comprises an automatic (or assisted opening) opening blade that exists a predefined region within the handle thereof, in response to the user's activation of an opening element, the novel instrument is advantageously provided with an actuating mechanism connected to at least one protective element that is operable to automatically cause the at least one protective element to extend into its active position in conjunction with the blade's automatic opening movement. Optionally, the inventive instrument may be configured such that actuation of the at least one protective element by the user activates an automatic (or assisted opening) mechanism operable to release the blade into an open position in response to activation of the at least one protective element.

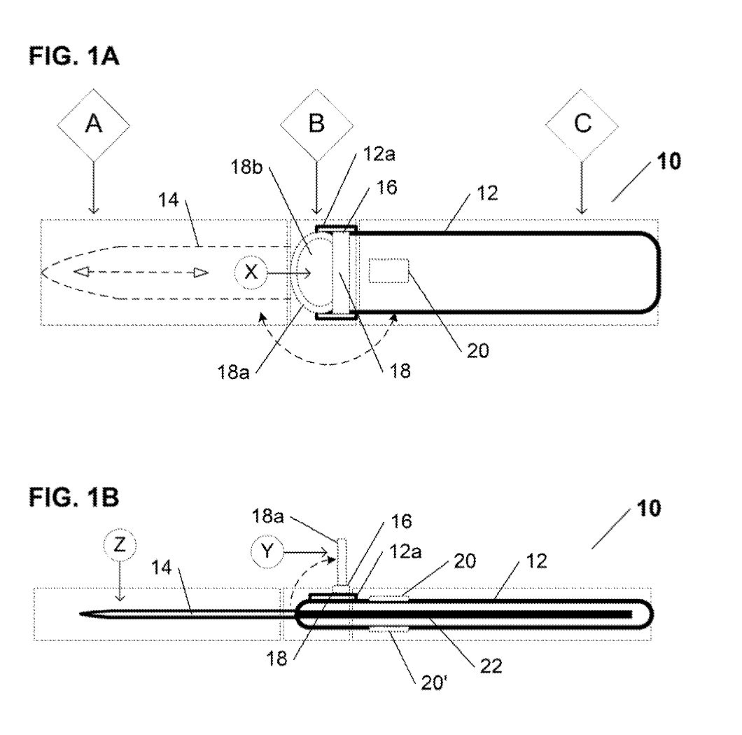

Referring now to FIGS. 1A-1B, a first exemplary embodiment of the inventive hand-held apparatus is shown in top-down, and side views, by way of example only, as a knife 10 having an automatically deployable blade component 14 (i.e., serving as the “active component”), and comprising at least one user-operable retractable protective element 18, that is advantageously configured for automatically moving into a protective position Y, by way of a spring-loaded (or equivalently powered) mechanism 16, in response to selective actuation of a corresponding at least one actuating element 20 (or 20′).

In at least one embodiment of the present invention, the actuating element 20 (or 20′) is also operable to cause the blade component 14 to deploy. Said at least one protective element 18 is shown in an inactive retracted position X in FIG. 1A, and in an activated extended position Y in FIG. 1B. The actuating element 20 (or 20′) may be configured as any suitable mechanical actuating component, such as a button, a lever, a slide, a latch, a trap door, etc., as a matter of design choice without departing from the spirit of the invention.

Similarly, the protective element 18 may be readily provided in a variety of shapes, sizes, and/or configurations, as a matter of design choice without departing from the spirit of the invention. By way of example only, the protective element 18 shown in FIGS. 1A-1B may be configured as a ring-like structure with an outer rim 18a, and an inner region 18b (which may be fully or partially filled with embellished and/or unembellished features, or which may be hollow). Furthermore, the protective element 18 may optionally comprise one or more additional esthetic embellishments, and/or decorative components mounted thereon.

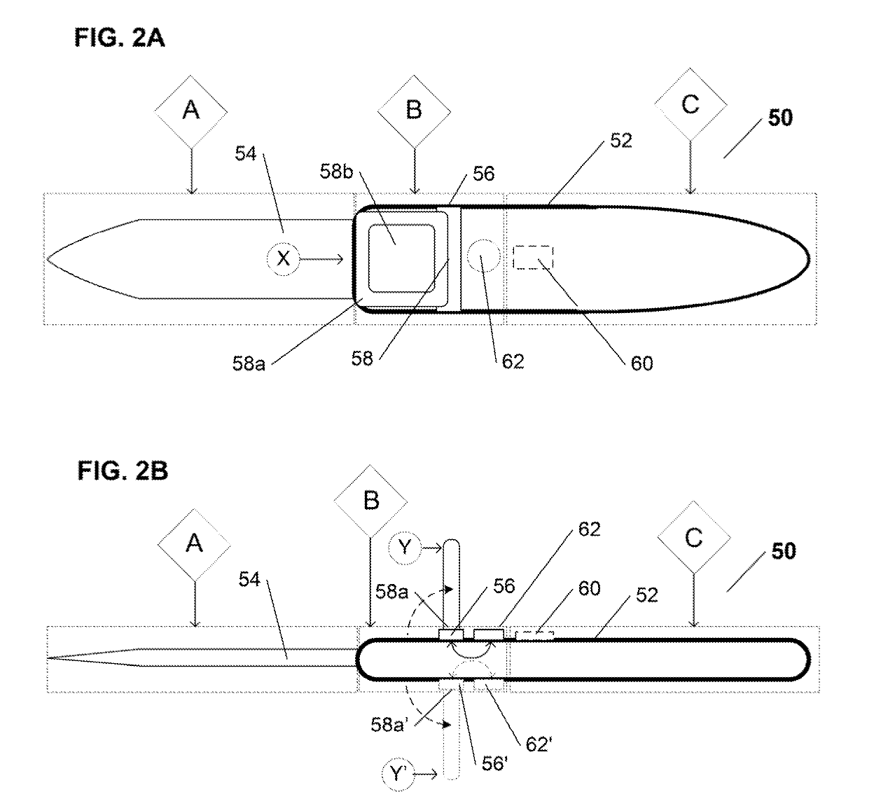

Referring now to FIGS. 2A-2B, a second exemplary embodiment of the inventive hand-held apparatus is shown in top-down and side views, as an instrument 50 (e.g., a knife) 50, having a handle 52 (which may be of any suitable or desired material (or combination of materials), and which may optionally include one or more decorative and/or embellishment features), and a fixed (or optionally folding, or retracting (linearly or otherwise)) active component 54 (which may be a blade, etc.), and further comprising at least one user-operable retractable protective element 58, that is advantageously configured for automatically moving, by way of a spring-loaded (or equivalently powered) mechanism 56, into a protective position Y, in response to selective actuation of a corresponding at least one dedicated actuating element 62 (and/or 62′), which may be provided solely for such selective actuation thereof by the user. Said at least one protective element 58 is shown in an inactive retracted position X in FIG. 2A, and in the activated extended position Y, in FIG. 2B. The actuating element(s) 62 (and/or 62′) may be configured as any mechanical actuating components such as a button, a lever, a slide, a latch, a trap door, etc. as a matter of design choice without departing from the spirit of the invention.

Referring now to FIG. 2B, an alternate embodiment of the inventive instrument 50 is illustrated, by way of example, in which a pair of protective elements 56, 56′ are provided, that are shown in their activated extended positions Y, Y′. Optionally, if the active component 54 is configured for folding (or retracting) into the handle 52, an optional release and/or locking mechanism may be readily provided therefor, that is at least in part positioned within the handle 52 (not shown), and that may be activated by at least one of the actuating elements 62, 62′, or, alternately, that may be activated by an optional dedicated actuating element 60 (which may be positioned on any desired region of the handle component 52, but which is shown on one of the side surfaces thereof by way of example only).

It should be noted that in the above-described exemplary embodiments of the present invention, the respective mechanisms 16, 26 (of FIGS. 1A, and 2A) are shown as being at least partially disposed within the respective handle components 12, 52. However, in a another exemplary embodiment of the present invention, at least one of the inventive protective elements, its activating mechanism, and its corresponding actuating element, may be readily and advantageously configured as a protective mechanical component assembly positioned on a support element (such as a substantially planar flat platform), that may be attached (e.g., surface mounted, welded on, screwed on, (with or without use of adhesive cement or equivalent) to a predetermined suitable area of the handle component of any hand-held instrument, having at least one region thereon sized and configured to receive at least one such protective assembly thereon, to thereby advantageously provide at least one protective element functionality to virtually any type of a hand-held instrument, regardless of size thereof, and regardless of whether the instrument has a fixed, or manually, or mechanically actuated folding (or retracting/extending) active component.

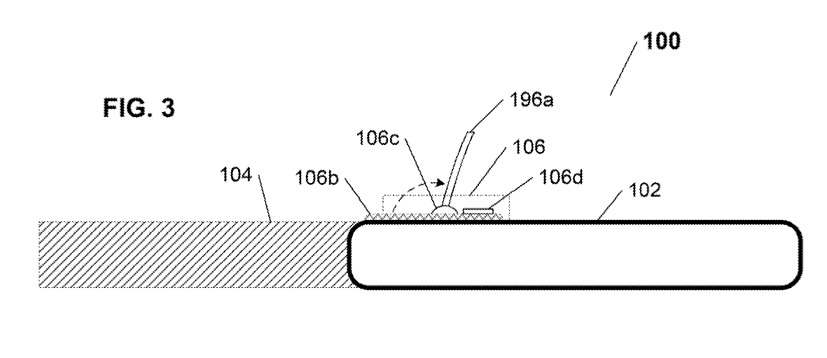

By way of illustrative example, referring now to FIG. 3, a third exemplary embodiment of the inventive hand-held apparatus is shown, in top-down and side views, as a hand-held instrument 100, having a predetermined active component 104 extending from a handle component 102, and comprising an inventive active protective assembly 106 mounted thereon.

The inventive protective assembly 106 comprises, a user-operable retractable protective element 106a (which is shown, by way of example only, as having a generally curved shape), that is advantageously configured for automatically moving, by way of a provided spring-loaded (or equivalently powered) mechanism 106c, into a protective position, preferably substantially perpendicular to the handle 102, in response to selective actuation, by a user, of a corresponding provided actuating element 106d. Advantageously, the elements/components 106a, 106c, and 106f, are positioned and mounted on a correspondingly sized and configured support platform 106b, that is mounted on (and affixed to) the handle component 102.

It should be noted that a single protective assembly 106 is shown in FIG. 3 by way of example only, and that any number of protective assemblies 106 may be circumferentially mounted on a handle 102, as a matter of design choice, without departing from the spirit of the invention. For example, if the handle component 102 is four-sided, one protective assembly 106 may be positioned on each of the four sides in the same circumferential plane, such that when all protective assemblies 106 are extended into their activated positions, the protective elements 106a would all be positioned in the same plane, substantially perpendicular to the handle component 102.

Finally, it should be noted that in various above-described embodiments of the present invention, the various components and elements of the novel instruments constructed and configured in accordance with the present invention, may be composed of any suitable materials or combination of materials, and may be sized to various desired scales as a matter of design choice without departing from the spirit of the invention.

Thus, while there have been shown and described and pointed out fundamental novel features of the inventive system and method as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A hand-held apparatus operable by a user to perform at least one predefined task, having an active component configured for performance of the at least one predetermined task, and having a sequentially positioned handle component, sized and configured for being held in the user's hand, and for enabling the user to operate the active component, said hand-held apparatus comprising:
at least one selectively deployable protective element, positioned in a predetermined mounting region proximal to a region in which the front end of the handle component is in substantial contact with the back end of the active component, said at least one protective element being operable for deployment, in response to actuation thereof by the user, from an inactive position in which said at least one protective element is positioned substantially parallel to a longitudinal axis of the handle component, to an activated position, in which said at least one protective element is positioned at a sufficient angle to said handle longitudinal axis to serve as a protective guard for at least a portion of at least one of the user's hand, and the user's fingers.

2. The hand-held apparatus of claim 1, wherein the active component is selected from a group consisting of at least: a blade, a saw, a tool component, and a spike.

3. The hand-held apparatus of claim 1, wherein the active component is at least one of: attached to the handle component in a fixed manner, or is formed at least partially integral with at least a portion of the handle component.

4. The hand-held apparatus of claim 1, wherein the handle component further comprises a housing region along said longitudinal axis thereof, sized and configured to receive therein and to retain a predetermined longitudinal portion of the active component, and wherein the active component comprises a selectively deployable active element that is sized, configured and positioned for selective deployment thereof by the user, from a first position in which said active element is at least partially housed within said housing region, to a second position in which said active element is fully extended from the front end of the handle component along said longitudinal axis.

5. The hand-held apparatus of claim 4, in which said deployment of said active element between said first and said second positions thereof, comprises one of: unfolding and folding of said active element from, and into, said housing region, or extending and retracting of said active element from, and into, said housing region.

6. The hand-held apparatus of claim 4, further comprising at least one user operable retaining means for retaining the extended active element in said second position, and being operable by the user to selectively enable said active element to be returned to its first position at least partially withinin said housing region.

7. The hand-held apparatus of claim 6, further comprising at least one user-operable mechanical deployment means for enabling, in cooperation with said retaining means, said active element to be selectively deployed by the user between said first and said second positions.

8. The hand-held apparatus of claim 7, wherein said deployment means comprise at least one of: a pivoting means, an assisted opening means, and an automatic opening means.

9. The hand-held apparatus of claim 8, further comprising, when said deployment means comprises at least one of: said assisted opening means, or said automatic opening means, automatic protective actuation means for automatically deploying said at least one protective element from said inactive position to said activated position in response to activation of said deployment means by the user.

10. The hand-held apparatus of claim 9, further comprising at least one control means, positioned proximally to said at least one protective element, operable by the user to selectively activate at least one of said deployment means, and said automatic protective actuation means to thereby cause said active element to deploy into said second position and said at least one protective element to deploy into said activated position.

11. The hand-held apparatus of claim 10, wherein said at least one control means is further operable to selectively deactivate at least one of said deployment means, and said automatic protective actuation means to thereby selectively cause said active element to return into said first position and/or selectively cause said at least one protective element to retract into said inactive position.

12. The hand-held apparatus of claim 11, wherein said at least one control means comprises at least one of a button, a lever, a slide, a latch, or a trap door.

13. The hand-held apparatus of claim 1, further comprising a protection control means selectively operable by the user to control deployment of said at least one protective element between said inactive and said activated positions.

14. The hand-held apparatus of claim 13, wherein said at least one protective control means comprises at least one of a button, a lever, a slide, a latch, or a trap door.

15. The hand-held apparatus of claim 1, wherein said at least one protective element comprises a shield component.

16. The hand-held apparatus of claim 15, wherein said at least one shield component comprises a central region, and at least partially circumferentially positioned outer rim element.

17. The hand-held apparatus of claim 16, wherein said central region, comprises at least one of a solid surface, and a surface comprising at least one hollow region.

18. The hand-held apparatus of claim 15, wherein said at least one shield component comprises at least one embellishment.

19. The hand-held apparatus of claim 15, wherein said at least one shield component comprises at least one decorative feature.
